(19) United States
(12) Patent Application Publication
(10) Pub. No.: US 2020/0358051 A1
(43) Pub. Date: Nov. 12, 2020

(54) BATTERY PACK ASSEMBLY AND A METHOD OF ASSEMBLING THE BATTERY PACK ASSEMBLY

(71) Applicant: GM Global Technology Operations LLC, Detroit, MI (US)

(72) Inventor: Evan J. Dawley, Bloomfield Hills, MI (US)

(73) Assignee: GM Global Technology Operations LLC, Detroit, MI (US)

(21) Appl. No.: 16/405,486

(22) Filed: May 7, 2019

(51) Int. Cl. H01M 2/10; H01M 10/04

(52) U.S. Cl. CPC H01M 2/1016; H01M 10/0486; H01M 10/0468

(57) ABSTRACT

A battery pack assembly includes a battery cell and a first plate. A body of the battery cell includes a first tab and a second tab. The first plate includes a first edge and a second edge opposing each other. The first plate defines a slot having a first portion and a second portion adjoining with each other. The first portion of the slot is defined through the first edge of the first plate such that the slot is open at the first edge. The first portion of the slot tapers toward the second portion. The first tab is disposed in the first portion of the slot at the first edge in an initial position. The first tab is disposed in the second portion of the slot in a final position to couple the battery cell and the first plate together.

### INTRODUCTION

Electric vehicles and hybrid vehicles include a battery pack to supply power to drive one or more wheels of the vehicle during certain modes of operation. The battery pack may include a module formed of separate pieces, and the module houses a battery formed of a plurality of cells.

### SUMMARY

The present disclosure provides a battery pack assembly that includes a battery cell and a first plate. The battery cell includes a body having a first end and a second end spaced from each other. The body includes a first tab attached to the first end and a second tab attached to the second end. The first plate includes a first edge and a second edge opposing each other. The first plate defines a slot having a first portion and a second portion adjoining with each other. The first portion of the slot is defined through the first edge of the first plate such that the slot is open at the first edge. The first portion of the slot tapers toward the second portion. The first tab is disposed in the first portion of the slot at the first edge in an initial position. The first tab is disposed in the second portion of the slot in a final position to couple the battery cell and the first plate together.

The present disclosure provides another battery pack assembly that includes a plurality of battery cells electrically connected to each other to present a cell stack. Each of the battery cells includes a body having a first end and a second end spaced from each other. The body of each of the battery cells includes a first tab attached to the first end of the body of the respective battery cells and a second tab attached to the second end of the body of the respective battery cells. The battery pack assembly also includes a first plate and a second plate spaced from each other. The cell stack is disposed between the first and second plates. Each of the first and second plates includes a first edge and a second edge opposing the respective first edge. The first plate and the second plate each define a plurality of slots, and the slots of the first plate substantially align with the slots of the second plate. The slots of the first and second plates each have a first portion and a second portion adjoining with the respective first portion. The first portion of the slots of the first plate is defined through the first edge of the first plate such that the slots of the first plate are open at the first edge of the first plate. The first portion of the slots of the first plate tapers toward the respective second portion of the first plate. The first portion of the slots of the second plate is defined through the first edge of the second plate such that the slots of the second plate are open at the first edge of the second plate. The first portion of the slots of the second plate tapers toward the respective second portion of the second plate. The first and second tabs are disposed through respective slots of the respective first and second plates to couple the battery cells and the first and second plates together via the cell stack and the first and second plates being disposed in an initial position, and then disposed in a final position after the initial position. The first tab of the battery cells is disposed in the first portion of the respective slots at the first edge of the first plate when in the initial position, and the second tab of the battery cells is disposed in the first portion of the respective slots at the first edge of the second plate when in the initial position. The first tab of the battery cells is disposed in the second portion of the respective slots of the first plate when in the final position, and the second tab of the battery cells is disposed in the second portion of the respective slots of the second plate when in the final position.

The present disclosure provides a method of assembling a battery pack assembly. A housing and a cell stack are positioned relative to each other. A lid plate of the housing is removed to access a cavity of the housing. Tabs of the cell stack are aligned relative to respective slots of a first plate of the housing and respective slots of a second plate of the housing. The slots are open at a first edge of the first and second plates, and the slots narrow as the slots extend away from the first edge of the respective first and second plates. The respective tabs of the cell stack are inserted in the respective slots at the first edge of the respective first and second plates by moving the housing and/or the cell stack to dispose the cell stack in the cavity of the housing.

The detailed description and the drawings or FIGS. are supportive and descriptive of the disclosure, but the claim scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic exploded perspective view of a battery pack assembly.

FIG. 2 is a schematic fragmentary cross-sectional view of a lid plate, a thermal interface material, and a plurality of battery cells.

FIG. 3 is a schematic perspective view of a housing with the lid plate removed, and a cell stack disposed inside the housing, with tabs of the cell stack disposed in respective slots of respective first and second plates in a final position.

FIG. 4 is a schematic fragmentary side view of an outside of the first and second plates defining a plurality of slots of FIG. 3.

FIG. 5 is a schematic fragmentary perspective view of the battery pack assembly of FIG. 1, with the battery pack assembly flipped over 180 degrees as compared to FIG. 1.

FIG. 6 is a schematic fragmentary perspective view of the housing from inside the housing.

FIG. 7 is a schematic fragmentary top view of a group of tabs of the battery cells disposed in the slot of one of the first and second plates in an initial position.

FIG. 8 is a schematic fragmentary top view of a plurality of groups of tabs of the battery cells disposed in respective slots of one of the first and second plates in the final position.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims. Furthermore, the term “substantially” can refer to a slight imprecision or slight variance of a condition, quantity, value, or dimension, etc., some of which that are within manufacturing variance or tolerance ranges.

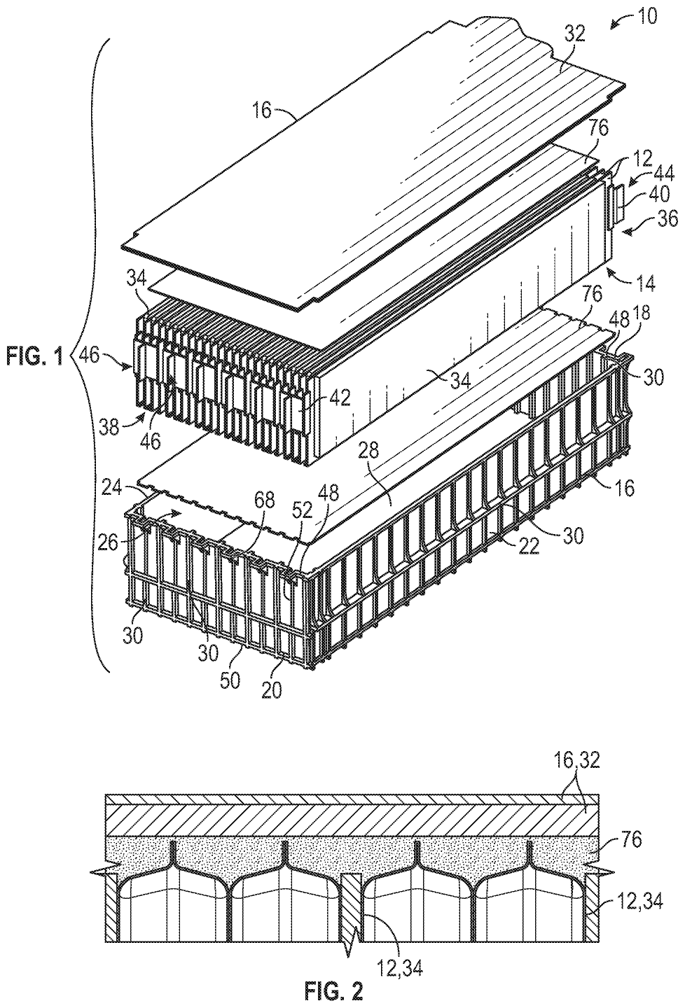

Referring to the FIGS., wherein like numerals indicate like or corresponding parts throughout the several views, a battery pack assembly 10 is generally shown in FIG. 1.

The battery pack assembly 10 may be used in a vehicle, such as, but not limited to, an automobile, an off-road vehicle, a watercraft, an aircraft, or any other suitable movable platform. As non-limiting examples, the vehicle may be a hybrid vehicle or an electric vehicle. The hybrid vehicle may include an internal combustion engine and one or more electric motors to drive wheels of the vehicle. The electric vehicle may include one or more electric motors to drive the wheels of the vehicle.

The battery pack assembly 10 may store power and/or provide power to operate the electric motors that drive the wheels of the vehicle. As another example, the battery pack assembly 10 may store power and/or provide power to various auxiliary systems, such as a radio, one or more pumps, lights, etc. The battery pack assembly 10 may also be used in a non-vehicle system, such as, a power plant, etc.

Referring to FIGS. 1 and 2, the battery pack assembly 10 includes a battery cell 12. The battery cell 12 may be configured to store power and/or provide power to various components, some of which as discussed above. In certain configurations, more than one battery cell 12 may be used. Therefore, the battery pack assembly 10 may include a plurality of the battery cells 12 electrically connected to each other to present a cell stack 14. The battery cells 12 may be any suitable configuration, and include any suitable material(s) to store power. One example of a suitable type of the battery cells 12 may be pouch cells which are formed of very thin foils.

The battery pack assembly 10 may also be referred to as a battery module or battery module assembly. One or more battery pack assemblies 10 or battery modules may be electrically connected together to provide the desired voltage to operate various components. The below discussion refers to one battery pack assembly 10, but it is to be appreciated that any suitable number of battery pack assemblies 10 may be used, and be configured as discussed below.

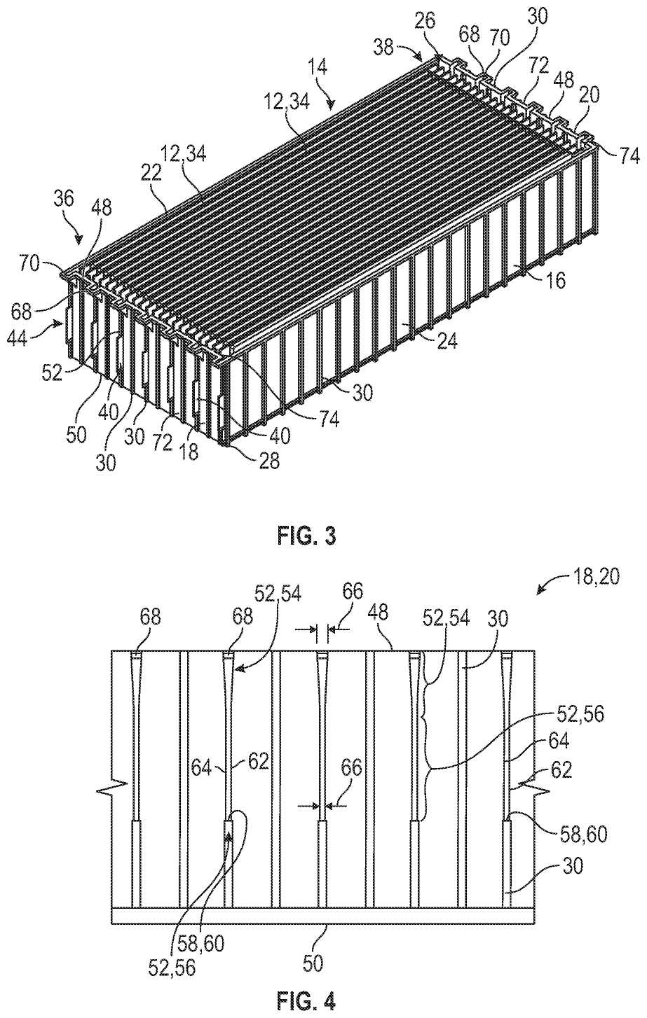

Referring to FIGS. 1 and 3, the battery pack assembly 10 may include a housing 16 that contains various components of the battery pack assembly 10. The housing 16 protects the battery cells 12. For example, if pouch cells are used, which are formed of very thin foils, the housing 16 protects these cells from damage during assembly.

Referring to FIG. 3, the housing 16 may include a first plate 18 and a second plate 20 spaced from each other. The housing 16 may also include a first side plate 22 and a second side plate 24 each attached to the first and second plates 18, 20 to define a cavity 26 therebetween. In other words, the first and second plates 18, 20 and the first and second side plates 22, 24 cooperate to surround the cavity 26. Additionally, the housing 16 may include a bottom plate 28 attached to the first and second side plates 22, 24 and the first and second plates 18, 20 to close one end of the cavity 26.

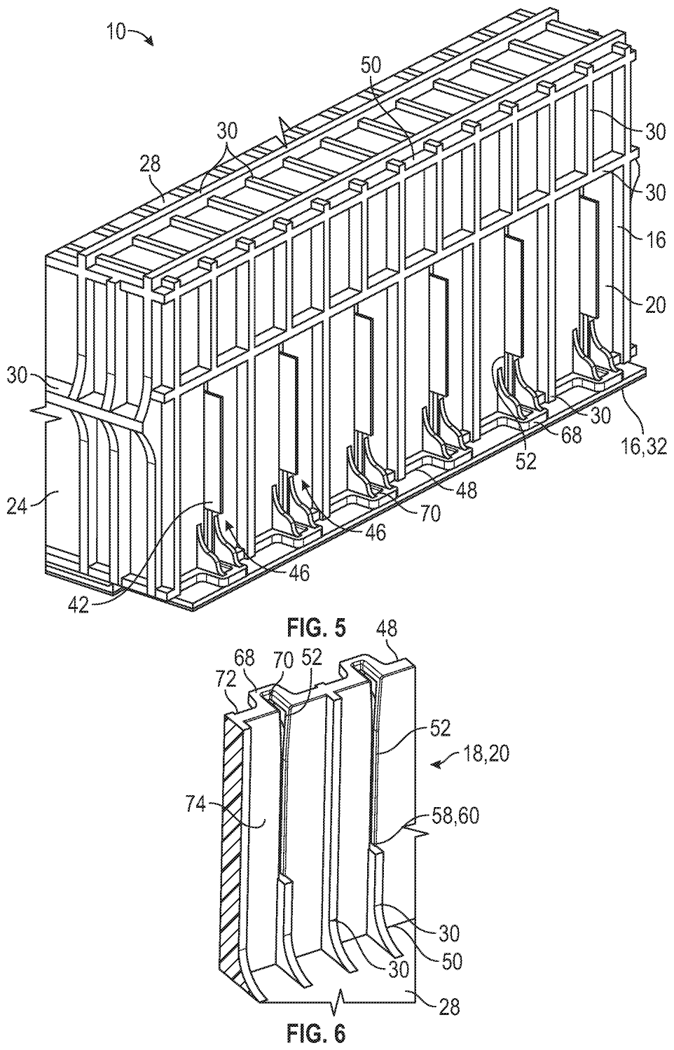

Referring to FIGS. 3-6, optionally, the housing 16 may include one or more ribs 30 to increase structural integrity of the housing 16. For example, the first and second plates 18, 20, the first and second side plates 22, 24, and/or the bottom plate 28 may include one or more of the ribs 30. As best shown in FIGS. 5 and 6, the ribs 30 may be disposed outside (see FIG. 5) and/or inside (see FIG. 6) of the housing 16.

The housing 16 may be formed of separate pieces that are attached to each other or the housing 16 may be formed of a single integral structure. Therefore, in certain configurations, the bottom plate 28, the first plate 18, the second plate 20, the first side plate 22, and the second side plate 24 are integrally formed to each other to present a one-piece housing as shown in FIGS. 1 and 3. Therefore, five sides of the housing 16 (the bottom plate 28, the first plate 18, the second plate 20, the first side plate 22, and the second side plate 24) may be formed as a one-piece structure. The housing 16 may be formed of one or more polymer materials, etc., and may be formed by molding, etc. By creating a one-piece housing, the number of separate components may be reduced which saves assembly costs.

As best shown in FIGS. 1 and 3, the housing 16 is open at one end during the assembly process. Therefore, the housing 16 may include a lid plate 32 (see FIG. 1) that is separate from the one-piece housing 16 to provide access to the cavity 26 of the housing 16 during the assembly process. The lid plate 32 is attached to the first and second plates 18, 20 and/or the first and second side plates 22, 24 after the battery cell 12 or the cell stack 14 is disposed in the cavity 26 in order to close the housing 16. FIG. 5 illustrates the housing 16 closed via the lid plate 32.

Turning to FIGS. 1 and 3, the battery cell 12 includes a body 34 having a first end 36 and a second end 38 spaced from each other. As best shown in FIG. 1, the body 34 includes a first tab 40 attached to the first end 36 and a second tab 42 attached to the second end 38. In other words, the first and second tabs 40, 42 are fixed to the body 34. The body 34 of the battery cell 12 is disposed in the cavity 26, and as best shown in FIGS. 3 and 5, part of the first tab 40 protrudes outside of the first plate 18 when the battery cell 12 is disposed in the housing 16, and part of the second tab 42 protrudes outside of the second plate 20 when the battery cell 12 is disposed in the housing 16. The first and second tabs 40, 42 protrude outside of the housing 16 to electrically connect the battery cell 12 to other components, such as a busbar and/or a circuit board, etc.

For the configuration that uses a plurality of battery cells 12, each of the battery cells 12 may include the body 34 having the first end 36 and the second end 38 spaced from each other, as discussed above for a single battery cell 12. Furthermore, the body 34 of each of the battery cells 12 may include the first tab 40 attached to the first end 36 of the body 34 of the respective battery cells 12 and the second tab 42 attached to the second end 38 of the body 34 of the respective battery cells 12, as discussed above for the single battery cell 12.

Turning to FIGS. 1, 7, and 8, with regard to having the plurality of battery cells 12, the first tab 40 of some of the battery cells 12 may be connected to each other to form a first group 44 of the first tabs 40, and similarly, the second tab 42 of some of the battery cells 12 may be connected to each other to form a second group 46 of the second tabs 42. It is to be appreciated that a plurality of first groups 44 of the first tabs 40 and a plurality of second groups 46 of the second tabs 42 may be created depending on the number of battery cells 12 being used.

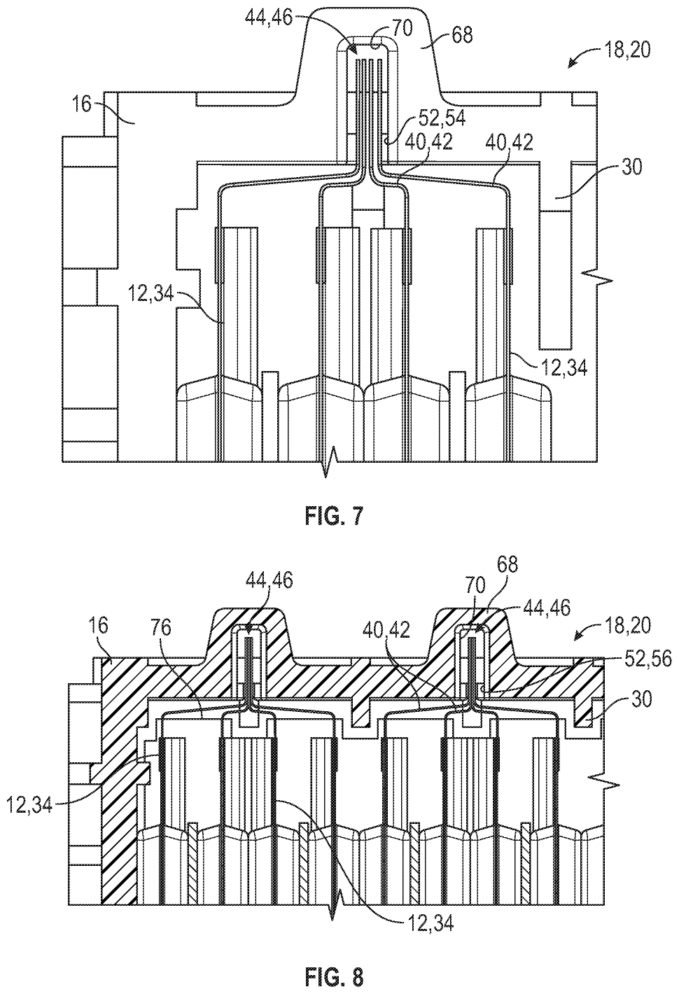

FIGS. 7 and 8 are illustrative for both the first group 44 of the first tabs 40 and the second group 46 of the second tabs 42. Initially, as shown in FIG. 7, the first tab 40 of the battery cells 12 may be pre-bent near each other to initially form the first group 44, and similarly, the second tab 42 of the battery cells 12 may be pre-bent near each other to initially form the second group 46. Finally, as shown in FIG. 8, the first tab 40 of the battery cells 12 may be ganged together to complete the first group 44, and similarly, the second tab 42 of the battery cells 12 may be ganged together to complete the second group 46. The first and second groups 44, 46 will be discussed further below.

The battery pack assembly 10 includes the first plate 18, and the first plate 18 may be part of the housing 16 as discussed above. As best shown in FIG. 3, the first plate 18 includes a first edge 48 and a second edge 50 opposing each other. The lid plate 32 may be attached to the first edge 48 of the first plate 18, and the bottom plate 28 may be attached or integral with the second edge 50 of the first plate 18.

As best shown in FIG. 4, the first plate 18 defines a slot 52 having a first portion 54 and a second portion 56 adjoining with each other. As best shown in FIG. 6, the first portion 54 of the slot 52 of the first plate 18 is defined through the first edge 48 of the first plate 18 such that the slot 52 is open at the first edge 48. Turning back to FIG. 4, the second portion 56 of the slot 52 of the first plate 18 is disposed farther away from the first edge 48 of the first plate 18 than is the first portion 54 of the slot 52 of the first plate 18. Furthermore, the second portion 56 of the slot 52 of the first plate 18 is spaced from the first edge 48 of the first plate 18 and spaced from the second edge 50 of the first plate 18. The second portion 56 of the slot 52 is closed at a distal end 58 of the slot 52 to prevent further travel of the first tab 40 relative to the first plate 18. Therefore, the closed distal end 58 of the slot 52 may act as a stop.

The first tab 40 is inserted into the slot 52 to couple the battery cell 12 and the first plate 18 together. The first tab 40 is disposed in the first portion 54 of the slot 52 at the first edge 48 in an initial position. The first tab 40 is disposed in the second portion 56 of the slot 52 in a final position to couple the battery cell 12 and the first plate 18 together. Therefore, to assemble the battery cell(s) 12 and the first plate 18 together, the first tab 40 starts in the initial position and assembly is complete when the first tab 40 settles in the final position. FIG. 7 may illustrate the initial position, and FIGS. 3, 5, and 8 may illustrate the final position.

As best shown in FIG. 4, the first portion 54 of the slot 52 of the first plate 18 tapers toward the second portion 56. In certain configurations, the first portion 54 of the slot 52 of the first plate 18 narrows as the first portion 54 extends toward the second edge 50 of the first plate 18. Therefore, the first portion 54 of the slot 52 of the first plate 18 is wider than the second portion 56 to provide a lead-in that guides the first tab 40 into the slot 52, and the second portion 56 of the slot 52 of the first plate 18 is narrower than the first portion 54 to provide the desired position of the first tab 40 relative to the first plate 18. Furthermore, the lead-in may also cause the first group 44 of the first tabs 40 to move closer together as the first group 44 moves toward the second portion 56 of the slot 52 (compare FIGS. 7 and 8). Hence, the slots 52 may provide self-alignment of the first tabs 40 which reduces assembly costs.

Continuing with FIG. 4, more specifically, the first plate 18 may include a bottom wall 60, a first side wall 62 and a second side wall 64 that cooperate with each other to present a periphery of the slot 52. The first side wall 62 and the second side wall 64 oppose each other to define a width 66 between the first and second side walls 62, 64 of the first plate 18. The width 66 decreases between the first and second side walls 62, 64 along the first portion 54 of the first plate 18 as the first portion 54 tapers toward the second portion 56. As discussed above, the slot 52 tapers along the first portion 54 of the first plate 18, and therefore, the width 66 gradually decreases between the first and second side walls 62, 64 toward the second portion 56. The width 66 is substantially the same between the first and second side walls 62, 64 along the second portion 56 of the first plate 18. Therefore, the width 66 stays substantially the same along the second portion 56. Generally, the width 66 along the second portion 56 of the first plate 18 is less than the width 66 along the first portion 54 of the first plate 18.

The bottom wall 60 of the first plate 18 is spaced from the first and second edges 48, 50 of the first plate 18, and the bottom wall 60 closes the slot 52. Therefore, the bottom wall 60 of the first plate 18 may act as a stop to prevent further travel of the first tab 40 relative to the first plate 18 when the first tab 40 is in the final position.

Additionally, in certain configurations, the battery pack assembly 10 further includes the second plate 20 configured substantially the same as the first plate 18. Again, as discussed above, the second plate 20 may be part of the housing 16. The second plate 20 may include the same features discussed above for the first plate 18, and FIGS. 4 and 6 are illustrative of the features of both the first and second plates 18, 20.

Referring to FIG. 3, the second plate 20 includes a first edge 48 and a second edge 50 opposing each other. The lid plate 32 may be attached to the first edge 48 of the second plate 20, and the bottom plate 28 may be attached or integral with the second edge 50 of the second plate 20.

Referring to FIG. 4, the second plate 20 defines a slot 52 having a first portion 54 and a second portion 56 adjoining with each other. As best shown in FIG. 6, the first portion 54 of the slot 52 of the second plate 20 is defined through the first edge 48 of the second plate 20 such that the slot 52 is open at the first edge 48 of the second plate 20. Turning back to FIG. 4, the second portion 56 of the slot 52 of the second plate 20 is disposed farther away from the first edge 48 of the second plate 20 than is the first portion 54 of the slot 52 of the second plate 20. Furthermore, the second portion 56 of the slot 52 of the second plate 20 is spaced from the first edge 48 of the second plate 20 and spaced from the second edge 50 of the second plate 20. The second portion 56 of the slot 52 of the second plate 20 is closed at a distal end 58 of the slot 52 to prevent further travel of the second tab 42 relative to the second plate 20. Therefore, the closed distal end 58 of the slot 52 may act as a stop.

As discussed above, the first and second tabs 40, 42 are fixed to the body 34. Therefore, movement of the body 34 causes corresponding movement of the first and second tabs 40, 42. Furthermore, the second tab 42 of the battery cell 12 is disposed in the slot 52 of the second plate 20. So movement of the first tab 40 to the initial and final positions also causes movement of the second tab 42 to the initial position in the slot 52 of the second plate 20 and the final position in the slot 52 of the second plate 20. So similarly to the first tab 40, the second tab 42 starts in the initial position (see FIG. 7) and assembly is complete when the second tab 42 settles in the final position (see FIG. 8).

As best shown in FIG. 4, the first portion 54 of the slot 52 of the second plate 20 tapers toward the second portion 56 of the second plate 20. In certain configurations, the first portion 54 of the slot 52 of the second plate 20 narrows as the first portion 54 extends toward the second edge 50 of the second plate 20. Therefore, the first portion 54 of the slot 52 of the second plate 20 is wider than the second portion 56 to provide a lead-in that guides the second tab 42 into the slot 52, and the second portion 56 of the slot 52 of the second plate 20 is narrower than the first portion 54 to provide the desired position of the second tab 42 relative to the second plate 20. Furthermore, the lead-in may also cause the second group 46 of the second tabs 42 to move closer together as the second group 46 moves toward the second portion 56 of the slot 52 (compare FIGS. 7 and 8). Hence, the slots 52 may provide self-alignment of the second tabs 42 which reduces assembly costs.

Continuing with FIG. 4, more specifically, the second plate 20 may include a bottom wall 60, a first side wall 62 and a second side wall 64 that cooperate with each other to present a periphery of the slot 52. The first side wall 62 and the second side wall 64 oppose each other to define a width 66 between the first and second side walls 62, 64 of the second plate 20. The width 66 decreases between the first and second side walls 62, 64 along the first portion 54 of the second plate 20 as the first portion 54 tapers toward the second portion 56. As discussed above, the slot 52 tapers along the first portion 54 of the second plate 20, and therefore, the width 66 gradually decreases between the first and second side walls 62, 64 toward the second portion 56. The width 66 is substantially the same between the first and second side walls 62, 64 along the second portion 56 of the second plate 20. Therefore, the width 66 stays substantially the same along the second portion 56. Generally, the width 66 along the second portion 56 of the second plate 20 is less than the width 66 along the first portion 54 of the second plate 20.

The bottom wall 60 of the second plate 20 is spaced from the first and second edges 48, 50 of the second plate 20, and the bottom wall 60 closes the slot 52. Therefore, the bottom wall 60 of the second plate 20 may act as a stop to prevent further travel of the second tab 42 relative to the second plate 20 when the second tab 42 is in the final position.

Turning to FIG. 3, the first and second plates 18, 20 are spaced from each other. The body 34 of the battery cell 12 is disposed between the first and second plates 18, 20. More specifically, the cell stack 14, and specifically, the bodies 34 of the battery cells 12 of the cell stack 14, is disposed between the first and second plates 18, 20. During assembly, the cell stack 14 is disposed between the first and second plates 18, 20 such that the first and second tabs 40, 42 of the battery cells 12 are disposed in the first portion 54 of the respective slots 52 at the first edge 48 of the first and second plates 18, 20 respectively in the initial position. Next, during assembly, the cell stack 14 is disposed further between the first and second plates 18, 20 such that the first and second tabs 40, 42 of the battery cells 12 are disposed in the second portion 56 of the respective slots 52 of the first and second plates 18, 20 respectively when in the final position. The final position is best shown in FIG. 3.

In certain configurations, the first and second plates 18, 20 may define more than one slot 52. Therefore, the first plate 18 and the second plate 20 may each define a plurality of slots 52. In certain configurations, the slots 52 of the first plate 18 may substantially align with the slots 52 of the second plate 20. In other configurations, the slots 52 of the first plate 18 may be offset from the slots 52 of the second plate 20 (see FIG. 3). The slots 52 of the first and second plates 18, 20 each have the same features discussed above for the single slot 52 of the first and second plates 18, 20, and therefore, not all of the features will be repeated.

Referring to FIGS. 4 and 6, the first portion 54 of the slots 52 of the first plate 18 is defined through the first edge 48 of the first plate 18 such that the slots 52 of the first plate 18 are open at the first edge 48 of the first plate 18. The first portion 54 of the slots 52 of the first plate 18 tapers toward the respective second portion 56 of the first plate 18. Similarly, the first portion 54 of the slots 52 of the second plate 20 is defined through the first edge 48 of the second plate 20 such that the slots 52 of the second plate 20 are open at the first edge 48 of the second plate 20. The first portion 54 of the slots 52 of the second plate 20 tapers toward the respective second portion 56 of the second plate 20.

The first and second tabs 40, 42 are disposed through respective slots 52 of the respective first and second plates 18, 20 to couple the battery cells 12 and the first and second plates 18, 20 together. When some of the first tabs 40 are grouped together, one of the first groups 44 of the first tabs 40 may be disposed through one of the slots 52 of the first plate 18 and another one of the first groups 44 of the first tabs 40 may be disposed through another one of the slots 52 of the first plate 18, and so on depending on the number of slots 52 of the first plate 18. Similarly, when some of the second tabs 42 are grouped together, one of the second groups 46 of the second tabs 42 may be disposed through one of the slots 52 of the second plate 20 and another one of the second groups 46 of the second tabs 42 may be disposed through another one of the slots 52 of the second plate 20, and so on depending on the number of slots 52 of the second plate 20. Therefore, part of the first groups 44 of the first tabs 40 of the battery cells 12 may protrude outside of the first plate 18 when the cell stack 14 is disposed in the housing 16, and part of the second groups 46 of the second tabs 42 may protrude outside of the second plate 20 when the cell stack 14 is disposed in the housing 16.

Turning to FIGS. 3 and 6-8, the first edge 48 of the first plate 18 may include a band 68 that protrudes outwardly from the first plate 18 and surrounds the first portion 54 of the slot 52 at the first edge 48 to define a recess 70 that cooperates with the slot 52. More specifically, the recess 70 aligns and connects with the slot 52. The recess 70 receives the first tab 40 as the first plate 18 and the battery cell 12 are disposed in the initial position. Generally, the band 68 of the first plate 18 provides structural support to the first plate 18, which will be discussed further below.

Continuing with FIGS. 6-8, the first plate 18 may include a first side surface 72 and a second side surface 74 opposing the first side surface 72. The first and second edges 48, 50 of the first plate 18 are disposed between the first and second side surfaces 72, 74. The band 68 protrudes outwardly from one of the first and second side surfaces 72, 74 of the first plate 18. In certain configurations, the band 68 of the first plate 18 extends outwardly from the first side surface 72, and the second side surfaces 74 faces inside the cavity 26 of the housing 16. Therefore, the band 68 of the first plate 18 is outside of the cavity 26 of the housing 16. Furthermore, some of the ribs 30 may extend from the first side surface 72 and/or the second side surface 74 of the first plate 18.

Similarly to the first plate 18, the first edge 48 of the second plate 20 may include a band 68 that protrudes outwardly from the second plate 20 and surrounds the first portion 54 of the slot 52 at the first edge 48 to define a recess 70 that cooperates with the slot 52. More specifically, the recess 70 aligns and connects with the slot 52. The recess 70 receives the second tab 42 as the second plate 20 and the battery cell 12 are disposed in the initial position. As similarly discussed for the first plate 18, generally, the band 68 of the second plate 20 provides structural support to the second plate 20, which will be discussed further below.

The second plate 20 may include a first side surface 72 and a second side surface 74 opposing the first side surface 72. The first and second edges 48, 50 of the second plate 20 are disposed between the first and second side surfaces 72, 74. The band 68 protrudes outwardly from one of the first and second side surfaces 72, 74 of the second plate 20. In certain configurations, the band 68 of the second plate 20 extends outwardly from the first side surface 72, and the second side surfaces 74 faces inside the cavity 26 of the housing 16. Therefore, the band 68 of the second plate 20 is outside of the cavity 26 of the housing 16. Furthermore, some of the ribs 30 may extend from the first side surface 72 and/or the second side surface 74 of the second plate 20.

In certain configurations, as best shown in FIG. 3, more than one band 68 may be disposed along the first and/or second plates 18, 20. Therefore, the first edge 48 of the first plate 18 may include a plurality of bands 68 that protrude outwardly from the first plate 18 and the respective bands 68 surround the first portion 54 of the respective slots 52 at the first edge 48 of the first plate 18 to define a recess 70 that cooperates with the respective slots 52 of the first plate 18. Furthermore, the recess 70 of the bands 68 receives the respective first tabs 40 when the first plate 18 and the cell stack 14 are disposed in the initial position. The bands 68 provide structural support of the first edge 48 of the first plate 18 around the respective slots 52. In other words, the slots 52 of the first plate 18 may weaken the first plate 18 around the slots 52, so the band 68 connects the parts of the first plate 18 around the slots 52 along the first edge 48 of the first plate 18 to improve the structural integrity of the first plate 18.

Similarly, the first edge 48 of the second plate 20 may include a plurality of bands 68 that protrude outwardly from the second plate 20 and the respective bands 68 surround the first portion 54 of the respective slots 52 at the first edge 48 of the second plate 20 to define a recess 70 that cooperates with the respective slots 52 of the second plate 20. Furthermore, the recess 70 of the bands 68 receives the respective second tabs 42 when the second plate 20 and the cell stack 14 are disposed in the initial position. The bands 68 provide structural support of the first edge 48 of the second plate 20 around the respective slots 52. In other words, the slots 52 of the second plate 20 may weaken the second plate 20 around the slots 52, so the band 68 connects the parts of the second plate 20 around the slots 52 along the first edge 48 of the second plate 20 to improve the structural integrity of the second plate 20.

The present disclosure also provides a method of assembling the battery pack assembly 10. The housing 16 and the cell stack 14 are positioned relative to each other, with the lid plate 32 of the housing 16 removed to access the cavity 26 of the housing 16. Depending on the number of the tabs 40, 42, i.e., the first and second tabs 40, 42, being used, the tabs 40, 42 may be pre-bent into one or more first and second groups 44, 46 (see FIG. 7).

Next, the width of the cavity 26 is measured to determine if the cell stack 14 needs to be compressed to a desired width to fit inside the cavity 26. The width of the cavity 26 is measured between the first and second side plates 22, 24. The cell stack 14 is compressed if needed.

After the cell stack 14 is compressed, if needed, the tabs 40, 42 of the cell stack 14 are aligned relative to the respective slots 52 of the first plate 18 of the housing 16 and the respective slots 52 of the second plate 20 of the housing 16. More specifically, if the tabs 40, 42 are grouped together, then the first and second groups 44, 46 of the tabs 40, 42 of the cell stack 14 are aligned relative to the respective slots 52 of the first plate 18 of the housing 16 and the respective slots 52 of the second plate 20 of the housing 16.

The slots 52 are open at the first edge 48 of the first and second plates 18, 20. The slots 52 narrow as the slots 52 extend away from the first edge 48 of the respective first and second plates 18, 20. The respective tabs 40, 42 of the cell stack 14 are inserted in the respective slots 52 at the first edge 48 of the respective first and second plates 18, 20 by moving the housing 16 and/or the cell stack 14 to dispose the cell stack 14 in the cavity 26 of the housing 16. Therefore, the tabs 40, 42 start in the initial position at the recess 70 and the first portion 54 of the slots 52, and the tabs 40, 42 move through the respective slots 52 until the tabs 40, 42 are disposed in the final position, in which the cell stack 14 rests on the bottom plate 28 of the housing 16.

Referring to FIG. 8, as the tabs 40, 42 move from the initial position toward the final position, the first group 44 of the tabs 40, 42 moves toward each other, and the second group 46 of the tabs 40, 42 moves toward each other. Once the tabs 40, 42 of the first group 44 are disposed in the final position, the first group 44 of the tabs 40, 42 may be sandwiched together due to the width 66 of the slot 52 or may be sandwiched together by another process. Similarly, once the tabs 40, 42 of the second group 46 are disposed in the final position, the second group 46 of the tabs 40, 42 may be sandwiched together due to the width 66 of the slot 52 or may be sandwiched together by another process.

Referring to FIG. 1, the cell stack 14 is positioned substantially parallel to the bottom plate 28 of the housing 16 and remains substantially parallel to the bottom plate 28 when disposing the cell stack 14 inside the cavity 26 of the housing 16. Specifically, the tabs 40, 42 are substantially parallel to the recess 70 of the respective band 68 and the slots 52 of the respective first and second plates 18, 20 when the cell stack 14 is positioned in the cavity 26 of the housing 16. In other words, the first and second ends 36, 38 of the body 34 of the cell stack 14 do not need to be tilted to position the tabs 40, 42 in the respective slots 52.

Additionally, referring to FIGS. 1 and 2, a thermal interface material (TIM) 76 may be disposed in the cavity 26 of the housing 16. The TIM 76 is applied before the lid plate 32 closes the cavity 26, therefore, the TIM 76 may or may not be applied to the lid plate 32. The TIM 76 may be disposed in the cavity 26 of the housing 16 before disposing the cell stack 14 in the cavity 26 of the housing 16, and/or the TIM 76 may be disposed in the cavity 26 after the cell stack 14 is disposed in the cavity 26 of the housing 16. As such, in certain configurations, there may be TIM 76 disposed between the bottom plate 28 and the bodies 34 of the cell stack 14, and/or there may be TIM 76 disposed between the lid plate 32 and the bodies 34 of the cell stack 14. The TIM 76 fills open spaces in the cavity 26 between the cell stack 14. Therefore, the TIM 76 may be directly disposed on the cell stack 14. The TIM 76 may assist with structural integrity of the battery pack assembly 10 and/or assist with cooling the battery cells 12. The TIM 76 may be an adhesive which may be in a liquid form, a foam, a gap pad or filler, etc. The foam may be a soft foam or a hard foam or any other suitable foam TIM.

After the TIM 76 is disposed in the cavity 26, the TIM 76 may be cured with or without the lid plate 32 attached to the first plate 18, the second plate 20, the first side plate 22 and/or the second side plate 24 along the first edge 48. If the lid plate 32 is attached to the first plate 18, the second plate 20, the first side plate 22 and/or the second side plate 24 along the first edge 48 before curing the TIM 76, then some of the TIM 76 may bond to the lid plate 32 during curing. The lid plate 32 closes the cavity 26 of the housing 16. Also, the lid plate 32 may be a cooling plate which assists in cooling the battery cells 12. Referring to FIG. 5, the lid plate 32 overlaps the bands 68 when attached to the other plates 18, 20, 22, 24 of the housing 16. In other words, the bands 68 do not protrude beyond an outer periphery of the lid plate 32. Therefore, the lid plate 32 may protect the bands 68.

Next, the tabs 40, 42 may be attached to other components, such as the busbar and/or the circuit board. The tabs 40, 42 may be attached to the other components by welding, fasteners, adhesive, ultrasonic welding, laser welding, etc.

It is to be appreciated that the order or sequence of performing the method as discussed above is for illustrative purposes and other orders or sequences, and additional features, are within the scope of the present teachings.

While the best modes and other embodiments for carrying out the disclosure have been described in detail, those familiar with the art to which this disclosure relates will recognize various alternative designs and embodiments for practicing the disclosure within the scope of the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A battery pack assembly comprising:
a battery cell including a body having a first end and a second end spaced from each other, and the body includes a first tab attached to the first end and a second tab attached to the second end;
a first plate including a first edge and a second edge opposing each other;
wherein the first plate defines a slot having a first portion and a second portion adjoining with each other;
wherein the first portion of the slot is defined through the first edge of the first plate such that the slot is open at the first edge, and the first portion of the slot tapers toward the second portion; and
wherein the first tab is disposed in the first portion of the slot at the first edge in an initial position, and the first tab is disposed in the second portion of the slot in a final position to couple the battery cell and the first plate together.

2. The assembly as set forth in claim 1 wherein the second portion of the slot is disposed farther away from the first edge of the first plate than is the first portion of the slot.

3. The assembly as set forth in claim 2 wherein the second portion of the slot is spaced from the first edge of the first plate and spaced from the second edge of the first plate.

4. The assembly as set forth in claim 3 wherein the first portion of the slot narrows as the first portion extends toward the second edge.

5. The assembly as set forth in claim 4 wherein the second portion of the slot is closed at a distal end of the slot to prevent further travel of the first tab relative to the first plate.

6. The assembly as set forth in claim 1 wherein the first plate includes a bottom wall, a first side wall and a second side wall that cooperate with each other to present a periphery of the slot.

7. The assembly as set forth in claim 6 wherein the first side wall and the second side wall oppose each other to define a width between the first and second side walls.

8. The assembly as set forth in claim 7 wherein the width decreases between the first and second side walls along the first portion as the first portion tapers toward the second portion.

9. The assembly as set forth in claim 8 wherein the width is substantially the same between the first and second side walls along the second portion.

10. The assembly as set forth in claim 6 wherein the bottom wall is spaced from the first and second edges, and the bottom wall closes the slot.

11. The assembly as set forth in claim 1 wherein the first edge of the first plate includes a band that protrudes outwardly from the first plate and surrounds the first portion of the slot at the first edge to define a recess that cooperates with the slot, and wherein the recess receives the first tab as the first plate and the battery cell are disposed in the initial position.

12. The assembly as set forth in claim 11 wherein:
the first plate includes a first side surface and a second side surface opposing the first side surface;
the first and second edges of the first plate are disposed between the first and second side surfaces; and
the band protrudes outwardly from one of the first and second side surfaces.

13. The assembly as set forth in claim 1:
further including a second plate configured substantially the same as the first plate and including a first edge and a second edge opposing each other, and the second plate defines a slot having a first portion and a second portion adjoining with each other;
wherein the second plate is spaced from the first plate, and the second tab of the battery cell is disposed in the slot of the second plate; and
wherein the first portion of the slot of the second plate is defined through the first edge of the second plate such that the slot is open at the first edge of the second plate, and the first portion of the slot of the second plate tapers toward the second portion of the second plate.

14. The assembly as set forth in claim 13 further including a first side plate and a second side plate each attached to the first and second plates to define a cavity therebetween, with the body of the battery cell disposed in the cavity.

15. The assembly as set forth in claim 14 further including a bottom plate attached to the first and second side plates and the first and second plates to close one end of the cavity.

16. The assembly as set forth in claim 15 wherein the bottom plate, the first plate, the second plate, the first side plate, and the second side plate are integrally formed to each other to present a one-piece housing.

17. A battery pack assembly comprising:
a plurality of battery cells electrically connected to each other to present a cell stack, and each of the battery cells includes a body having a first end and a second end spaced from each other, and the body of each of the battery cells includes a first tab attached to the first end of the body of the respective battery cells and a second tab attached to the second end of the body of the respective battery cells;
a first plate and a second plate spaced from each other, with the cell stack disposed between the first and second plates, and each of the first and second plates includes a first edge and a second edge opposing the respective first edge;
wherein the first plate and the second plate each define a plurality of slots, and the slots of the first plate substantially align with the slots of the second plate;
wherein the slots of the first and second plates each have a first portion and a second portion adjoining with the respective first portion;
wherein the first portion of the slots of the first plate is defined through the first edge of the first plate such that the slots of the first plate are open at the first edge of the first plate, and the first portion of the slots of the first plate tapers toward the respective second portion of the first plate;
wherein the first portion of the slots of the second plate is defined through the first edge of the second plate such that the slots of the second plate are open at the first edge of the second plate, and the first portion of the slots of the second plate tapers toward the respective second portion of the second plate; and
wherein the first and second tabs are disposed through respective slots of the respective first and second plates to couple the battery cells and the first and second plates together, in which:
the cell stack is disposed between the first and second plates such that the first and second tabs of the battery cells are disposed in the first portion of the respective slots at the first edge of the first and second plates respectively in an initial position; and
the cell stack is disposed further between the first and second plates such that the first and second tabs of the battery cells are disposed in the second portion of the respective slots of the first and second plates respectively when in a final position.

18. The assembly as set forth in claim 17 wherein:
the first portion of the slots of the first plate narrows as the first portion of each of the slots of the first plate extends toward the second edge of the first plate; and
the first portion of the slots of the second plate narrows as the first portion of each of the slots of the second plate extends toward the second edge of the second plate.

19. The assembly as set forth in claim 18 wherein:
the first edge of the first plate includes a plurality of bands that protrude outwardly from the first plate and the respective bands surround the first portion of the respective slots at the first edge of the first plate to define a recess that cooperates with the respective slots of the first plate;
the recess of the bands receive the respective first tabs when the first plate and the cell stack are disposed in the initial position;
the first edge of the second plate includes a plurality of bands that protrude outwardly from the second plate and the respective bands surround the first portion of the respective slots at the first edge of the second plate to define a recess that cooperates with the respective slots of the second plate; and
the recess of the bands receive the respective second tabs when the second plate and the cell stack are disposed in the initial position.

20. A method of assembling a battery pack assembly, the method comprising:
positioning a housing and a cell stack relative to each other, with a lid plate of the housing removed to access a cavity of the housing;
aligning tabs of the cell stack relative to respective slots of a first plate of the housing and respective slots of a second plate of the housing, and wherein the slots are open at a first edge of the first and second plates, and the slots narrow as the slots extend away from the first edge of the respective first and second plates; and
inserting the respective tabs of the cell stack in the respective slots at the first edge of the respective first and second plates by moving the housing and/or the cell stack to dispose the cell stack in the cavity of the housing.
